(19) United States
(12) Patent Application Publication
(10) Pub. No.: US 2002/0113819 A1
(43) Pub. Date: Aug. 22, 2002

(54) Method for controlling a screen display

(76) Inventors: Dan Baer, Garden Grove, CA (US); Thomas C. Amon, Santa Ana, CA (US)

Correspondence Address: STETINA BRUNDA GARRED & BRUCKER, 75 ENTERPRISE, SUITE 250, ALISO VIEJO, CA, 92656, US

(21) Appl. No.: 10/001,149

(22) Filed: Nov. 15, 2001

Related U.S. Application Data
(60) Provisional application No. 60/249,847, filed on Nov. 17, 2000.

(51) Int. Cl. G09G 5/00; G06F 17/24

(52) U.S. Cl. 345/760; 345/788; 707/513

(57) ABSTRACT

The present invention may be regarded as a method for controlling a screen display having a screen width and a screen height. A portion of a web browser display is relocated off of the screen display. The size of the relocated web browser display is expanded.

A one cell HTML table is defined as the screen width/the screen height.

### CROSS-REFERENCE TO RELATED APPLICATIONS

This application claims the benefit of U.S. Provisional Application No. 60/249,847, filed Nov. 17, 2000, the entire contents of which are hereby incorporated by reference.

### STATEMENT RE: FEDERALLY SPONSORED RESEARCH/DEVELOPMENT

(Not Applicable)

### BACKGROUND OF THE INVENTION

The subject invention relates generally to screen displays and more particularly to a method for employing all pixels of a physical screen to exhibit the content of a display.

Computer systems in general are known. A typical computer system includes a computer, a keyboard, a mouse, and a monitor. Additionally, the computer includes a central processing unit (CPU) and random access memory (RAM) and allows various software programs to be used. Further, the computer system may include a modem, an Ethernet card or other similar device for connecting to a system of networked computers, such as the Internet.

The Internet provides a useful technique for making information available to a variety of individuals each of whom may be located at a variety of different locations. Indeed, within the vast Internet environment, individuals can access information tools from remote locations. The Internet, which originally came about in the late 1960's, is a computer network made up of many smaller networks spanning the entire globe. The host computers or networks of computers on the Internet allow public or private access to databases containing information in numerous areas of expertise. Hosts can be sponsored by a wide range of entities including, for example, universities, government organizations, commercial enterprises and individuals.

Internet information is made available to the public through servers running on an Internet host. The servers make documents or other files available to those accessing the host site. Such files can be stored in databases and on storage media such as, for example, optical or magnetic storage devices, preferably local to the host.

Networking protocols can be used to facilitate communications between the host and a requesting client. Transmission Control Protocol/Internet Protocol (TCP/IP) is one such networking protocol. Computers on a TCP/IP network utilize unique identification codes allowing each computer or host on the Internet to be uniquely identified. Such codes can include an Internet Protocol (IP) number or address and corresponding network and computer names.

Created in 1991, the World-Wide Web (Web, or www) provides access to information on the Internet, allowing a user to navigate Internet resources intuitively, without IP addresses or other specialized knowledge. The Web comprises hundreds of thousands of interconnected “pages” or documents that can be displayed on a user's computer monitor. The web pages are provided by hosts running special servers. Software that runs these web servers is relatively simple and is available on a wide range of computer platforms including personal computers (PCs). Equally available is web browser software used to display web pages, as well as traditional non-web files, on the user's system.

The Web is based on the concept of hypertext and a transfer method known as Hypertext Transfer Protocol (HTTP). HTTP is designed to run primarily over TCP/IP and uses the standard Internet setup where a server issues the data and a client displays or processes the data. One format for information transfer is to create documents using Hypertext Markup Language (HTML). HTML pages are made up of standard text as well as formatting codes indicating how to display the page. A browser reads these codes to display the page. The Web also uses the File Transfer Protocol (FTP) to transmit files between hosts. In particular, a method known as “anonymous FTP” allows a user to receive a file from a server without the server learning the identity of the user.

Each web page may contain pictures and sounds in addition to text. Associated with certain text, pictures or sounds are connections, known as hypertext links, to other pages within the same server or even on other computers within the Internet. For example, links may appear as underlined or highlighted words or phrases. Each link is directed to a web page by using a special name called a Uniform Resource Locator (URL). URLs enable the browser to go directly to the associated resource, even if it is on another web server.

In addition to the Internet which allows for general, public retrieval of information, other means of accessing such information exist and are commonly utilized. For example, direct modem connections between two computers, proprietary internal networks within large institutions and organizations, or the like, are equally available and useful means for accessing catalogued information stored in databases.

Some web pages and web sites provide media data. This data can be downloaded or presented as streaming data to a user. Streaming data may be the continuous transmission of data, for example, audio or video data. It is desirable for a provider of such data to transmit such data to a user quickly and reliably. Therefore, a need exists for a system for electronically transmitting electronic media data.

In delivery of advertising content over the Internet to a personal computer employing a web browser, it is desirable to have the capability to employ the entire display screen to display, for example, the content of the advertisement. Conventionally, this would require opening up a second window, which can prove annoying to the user and can present technical problems.

### BRIEF SUMMARY OF THE INVENTION

An aspect of the present invention may be regarded as a method for controlling a screen display having a screen width and a screen height. A portion of a browser display is relocated off of the screen display. The size of the relocated browser display is expanded. A one cell HTML table is defined as the screen width/the screen height.

The information stored in the one cell HTML table is displayed causing the displayed information to completely fill the screen display.

The displayed information may be an advertisement, for example, a flash advertisement.

An initial screen origin may be saved. The browser can then be restored to the saved initial screen origin after the one cell HTML table is displayed. The browser may be re-dimensioned by −screen width /−screen height. The screen display can then be refreshed.

The information may be displayed for a predetermined time period.

The portion of the browser display that is relocated off the screen may include a menu area. The menu area may be located at the top of the browser display. The portion of the browser display that is relocated off the screen may include a bar. The bar may be a left bar.

### BRIEF DESCRIPTION OF THE DRAWINGS

These, as well as other features of the present invention, will become apparent upon reference to the drawings, wherein:

FIG. 1 illustrates a typical computer display screen;

FIG. 2 illustrates a computer display screen including a browser display that is relocated so that the menu and left bar are off the screen;

FIG. 3 illustrates an expanded display; and

FIG. 4 illustrates a display screen that uses all of the pixels of the computer display screen.

### DETAILED DESCRIPTION OF THE INVENTION

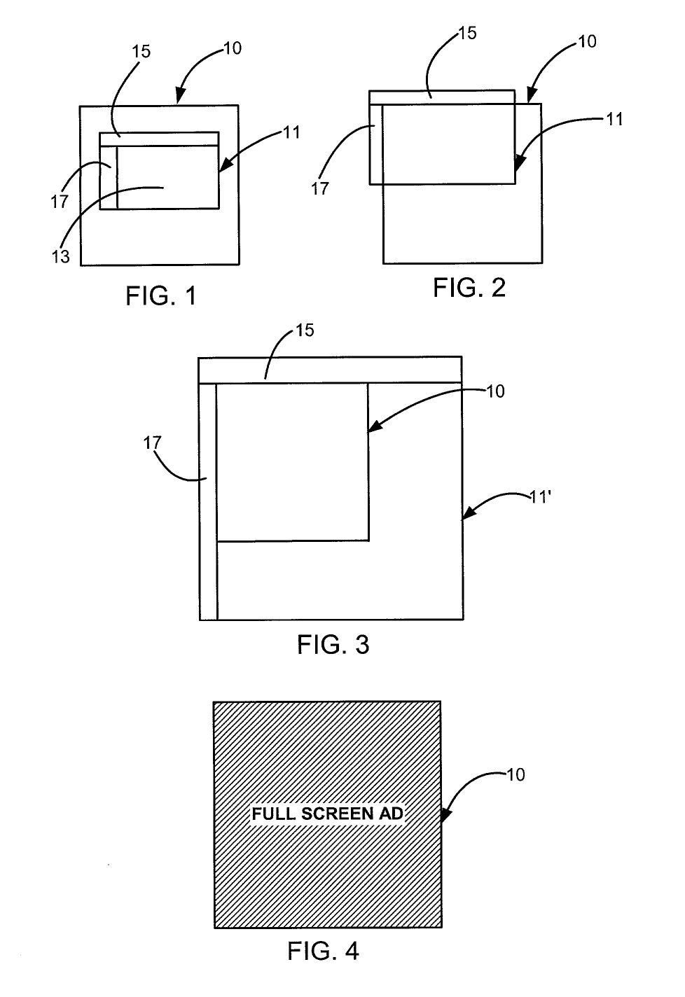

FIG. 1 illustrates a typical computer display screen 10, which may be, for example, a CRT monitor interconnected with a conventional personal computer (PC) running a web browser. In FIG. 1, the browser is open, resulting in a display 11. The display 11 may include a viewing area 13, a menu area 15 and a left bar 17 such as is shown in FIG. 1. It will be appreciated that other browser configurations may be possible in alternate embodiments of the invention. For example, there may not be any bar or there may be a right bar instead of a left bar. In the exemplary embodiments, the web browser is Internet Explorer® 5.5. Other web browsers may be adapted to provide the advantages of the method according to the invention. The method according to the invention may be triggered by receipt from a server of contents to be displayed (e.g., an HTML page) and a Java® script routine to control the browser display.

In exemplary embodiments, the browser display 11 is relocated so that the menu 15 and left bar 17 are off the screen 10, as shown in FIG. 2. This may be achieved by Java® script that calls a browser function to move the browser display's point of origin to the following location:

y−menu height

x−1

Next, the screen width (screen x) and height (screen y) are added to the existing display size resulting in expanding the display 11 so that it is exactly larger than the size of screen 10 by the dimensions of the original browser display 11. This results in an expanded display 11′, as shown in FIG. 3. This expansion step is facilitated by the ability to read the physical screen pixels in Java®.

Next, a one cell HTML table is defined, which is screen x/y (“x over y”). In this manner, all pixels of the screen are made available for display purposes.

When full screen mode is entered, the transmitted display is presented using all of the pixels of the screen, as shown in FIG. 4. An example of a display that might be presented is a flash advertisement display (“flash ad”). Such a display has the inherent ability to automatically fill the entire screen once all of the pixels are made available for display purposes.

After the display content is presented, the process is reversed to return to the original browser display state shown in FIG. 1. The duration of the presentation of the display content may be determined by a time-out operation or other technique known to those skilled in the art. The steps used in this reverse process are: (1) relocate to saved x/y, (2) re-dimension by −screen x/−screen y, and (3) Navigate −1. The first step (1) relocates the browser display origin to the original location x/y which has been saved. The second step re-dimensions the display from the enlarged form shown in FIG. 3 back to normal size, thereby returning to the original state. The third step executes a refresh, which restores the original frame set. The second step (2) may be implemented using a “hard code” technique or by equivalent approaches. The above method is implemented by a Java® script program transmitted from a server along with the display content. An example of such a program is as follows:

When the page is loaded into the browser the following is executed first.

<=====Calculate Current Browser and Physical Screen
parameters=====>
var xoffset = top.window.screen.width −
top.window.screen.availWidth;
var yoffset = top.window.screen.height − top
window.screen.availHeight;
var origx = top.window.screenLeft-xoffset;
var origy = top.window.screenTop-yoffset;
var destx = 0-xoffset;
var desty = 0-yoffset;
var destwidth = top.window.screen.width + xoffset;
var destheight = top.window.screen.height + yoffset;
top.window.moveTo (0, 0);

The Ideal Location of the left edge is 1 pixel to the left of the physical leftmost pixel

destx =(destx-top.window.screenLeft)−1;

The Ideal Location of the Top edge is 1 pixel above the physical top most pixel but we also have to account for the height of the menu areas

desty=(desty-top.window.screenTop+yoffset)−1;

Calculate the location where the browser will be restored to

origx=origx−4;

origy=(origy−top.window.screenTop)+yoffset;

Create the Restore Function that will be loaded into the browser

newContent += “<script language=Javascript>\r\n”;
newContent += “<!-- \r\n”;
newContent += “function restoreme () {\r\n”;
newContent += “top.window.moveTo (“ + origx + ”,” +

origy + “);\r\n”;

newContent += “top.window.resizeBy(−“ + destwidth =

“,−“ + destheight + “);\r\n”;

newContent += “top.history.go (−1);\r\n”;
newContent += “}\r\n”;

Make a one Cell Table that is exactly the screen width so that the centering function within the message will work.

newContent+=“<TABLE> <TR><td width=”+top.window.screen.width+“valign=top align=center border=0 cell spacing=0 cell padding=0>\r\n”;

<----- Actual Message Inserted Here ----->
Close the one cell table that is around the message content

newContent += “</td></tr></table>\r\n”;

<======= End of message creation by the browser script
=======>

Move the Browser Off Screen

top.window.moveTo(destx,desty);

Size the Browser Larger Than the Screen Pixels

top.window.resizeBy(destwidth,destheight);

Overwrite the Browser Content with the new content

top.document.write(newContent);

top.document.close( );

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A method for controlling a screen display having a screen width and a screen height, the method comprising:
a) relocating a portion of a browser display off of the screen display;
b) expanding the size of the relocated browser display; and
c) defining a one cell HTML table as the screen width/the screen height.

2. The method of claim 1, further comprising displaying information stored in the one cell HTML table, whereby the displayed information completely fills the screen display.

3. The method of claim 2, wherein the displayed information is an advertisement.

4. The method of claim 3, wherein the displayed information is a flash advertisement.

5. The method of claim 2 further comprising before (a), saving an initial screen origin; and after (c), (d) relocating the browser to the saved initial screen origin; and (e) re-dimensioning the browser.

6. The method of claim 5, further comprising after (e), refreshing the screen display.

7. The method of claim 5, wherein the browser is re-dimensioned by −screen width /−screen height.

8. The method of claim 2, wherein the information is displayed for a predetermined time period.

9. The method of claim 1, wherein the portion of the browser that is relocated off the display comprises a menu area.

10. The method of claim 9, wherein the menu area is located at the top of the browser display.

11. The method of claim 10, wherein the portion of the browser that is located off the display further comprises a bar.

12. The method of claim 11, wherein the bar is a left bar.

13. The method of claim 1, wherein the portion of the browser that is relocated off the display comprises a bar.

14. The method of claim 13, wherein the bar is a left bar.
